(19) United States
(12) Patent Application Publication
(10) Pub. No.: US 2004/0238236 A1
(43) Pub. Date: Dec. 2, 2004

(54) Weighing device

(76) Inventors: Benoit Linglin, Cruseilles (FR); Didier Anthoine-Milhomme, Albens (FR); Michel Sarrazin, Massingy (FR)

Correspondence Address: BROWDY AND NEIMARK, P.L.L.C., 624 NINTH STREET, NW, SUITE 300, WASHINGTON, DC, 20001-5303, US

(21) Appl. No.: 10/487,879

(22) PCT Filed: Sep. 5, 2002
(86) PCT No.: PCT/FR02/03018

(30) Foreign Application Priority Data
Sep. 5, 2001 (FR) 01/11499

(51) Int. Cl. G01G 3/08

(52) U.S. Cl. 177/229

(57) ABSTRACT

The invention relates to a weighing device comprising a rigid platform (10) which is intended to receive the weight to be measured, a fixed support area (20) and at least one weight sensor (30). One of the ends (60) of said sensor is embedded in the platform (10) while the opposite end (70) thereof is embedded in the fixed support area (20). The weight sensor (30) supports strain gauges (R1, Ri) and comprises a bar that can be deformed, mainly by means of flexion (40) under the effect of the weight applied to said platform. According to the invention, at least one of the embedded ends (60) of the weight sensor (30) is provided with a surface (S) that is intended to be directly fixed by means of adhesion to the rigid platform (10) or to the fixed support area (20).

The present invention relates to a weighing device of the bathroom scale or kitchen scale type having strain gauges associated with an electronic measuring circuit supplying a signal that is a function of the weight to be measured and it concerns more particularly the structure of such a device.

Such a weighing device comprises, in principle, a platform capable of receiving the weight to be measured, at least one test body having on one of its faces the strain gauges, one of the ends of this body being connected to the platform and the other to a base or a foot intended to rest on a flat surface. The two ends of this body are fitted to the platform and to the base and delimit a bar of an elastic material supporting the strain gauges and deformable essentially by flexure under the effect of the weight to be weighed. The gauges are connected to an electronic circuit to convert the deformations experienced by the gauges into an electric signal and to transform these latters into numerical values corresponding to the measured weight.

In such a device, the ends of the test body carrying the flexure bar must be solidly fixed with respect to the platform and the base in a manner such that the load applied on the platform creates a force that is taken into account well by the flexure bar.

Weighing devices of the type described in the document FR 2 554 229 in the name of the applicant have a test body in the form of a metal bar of square cross-section, the ends of which are rigidly fixed to the platform and to the base in a manner such that the bar can flex under the effect of the load applied on the platform. In order to resist elevated strains, the platform as well as the base must provide an attachment that is solid and thus requires a large volume of material. The bar is fixed to the attachment pieces in the base and the platform by means of flanges and fixation screws. Such a mechanical structure proves to be cumbersome and complex, since it relies on a substantial volume of material and a multitude of attachment pieces.

Another weighing device is described in the document EP 0 505 493. This device has a base and a platform resting on four weighing cells that have a flat form. Each weighing cell comprises a flexure bar having strain gauges, the flexure bar undergoing a deformation under the effect of the weight to be measured which is applied through the intermediary of a U-shaped element at one of the ends of the flexure bar, while the other extremity is fixed by a screw or by rivets to the base of the device. Such a type of attachment gives rise to high stresses at the points of attachment of the weighing cell and alters the metrologic characteristics of the device.

The goal of the present invention is to overcome the drawbacks cited above and to furnish a weighing device having good metrologic characteristics and having a long useful life.

Another goal of the invention is to provide a weighing device having a thin profile which is reliable in operation, being able to be produced by an assembly of parts of different materials, all while using a simple fabrication method.

A supplementary goal of the invention is a weighing device of simple structure, easy to manufacture on an industrial scale at a low fabrication cost.

These goals are achieved with a weighing device comprising a rigid platform intended to receive the weight to be measured, a fixed support zone and at least one weight sensor fixed at one of its ends to the platform and at the opposite end to the fixed support zone, said weight sensor having a bar that is deformable mainly by flexure under the effect of the weight applied on said platform and carrying strain gauges, by the fact that at least one of the fixing ends of said weight sensor presents a surface intended to be directly fixed by bonding to the rigid platform or to the fixed support zone.

By rigid platform is understood a part having generally the form of a plate made of a material having dimensions and mechanical characteristics causing it to resist deformations under the effect of the weight that comes to be applied onto its upper face. By sensor, there is understood a test body, the ends of which are embedded in the platform and the base and delimit a bar of an elastic material supporting strain gauges and deformable essentially by flexure under the effect of the weight to be measured. By bar deformable mainly by flexure, there is intended a bar that is deformable mostly by flexure, a minor component of torsional deformation being able to be added depending on the mode of attachment of the sensor by and the direction of application of the load.

Such a weighing device is produced by using an assembly by bonding between the weight senor an its support, for example between this latter and the rigid platform receiving the weight to be measured and/or between the sensor and the fixed support, notably the base or the foot of the device. For this, at least one of the ends of the sensor has a surface intended for bonding, a surface that can be a substantially flat surface or equally a curved surface, the form of this surface being a function of the form of the surface with which it comes into communication at the time of bonding.

The bonding consists in achieving an intimate chemical contact between two solids with the aid of an adhesive. Bonding implies thus the use of an additive material in the form of an adhesive applied in liquid or paste form or susceptible to become such, for example by heating, on the surface of at least one of the parts to be assembled, and to provoke a solidification of the adhesive in order to assure a strong and stable bond between the joined pieces. The bonding layer is created in the form of a continuous layer referred to as a joint, assuring a good transmission of mechanical forces between the components. The adhesive distributes the load over the entire surface of the joint, which assures a more uniform distribution of the static and dynamic strains instead of concentrating them at the points of high stress as, for example, in the case of a mechanical attachment with screws or rivets.

Thus, bonding is perfectly adapted to the assembly of the different materials, fragile materials and thin materials, while being adapted to transmit mechanical forces through the bond joint. Bonding permits, in addition, to increase manufacturing speed requiring, on the one hand, less need for parts to be assembled and permitting, on the other hand, automation of the manufacturing process.

Advantageously, said fitted end is directly fixed to the platform.

The sensor, being bonded by one of its ends to the rigid platform supporting the weight to be measured, the force is transmitted directly and uniformly to the sensor, notably to the deformable part of this latter, which causes the deformation of this latter to follow in a reliable manner the value of the load applied. It has thus been noted, during metrologic tests effectuated in the laboratory, that the linearity of a weighing device using a sensor connected by bonding to a rigid platform is clearly improved, remaining within the metrologic limits imposed by the existing standards, with respect to the same device using a sensor connected by screws to the platform.

In addition, a weighing device having a sensor directly bonded to the platform presents a very thin profile, since the assembly is free of any intermediate connecting piece.

Usefully, said flat surface defines a bonding zone per sensor inversely proportional to the number of weight sensors of the device.

The dimensions of the bonding zone are calculated as a function of the values of the strains applied to the sensor and of the manner of optimizing the connection by bonding of this latter with its support.

The dimensions and the mechanical characteristics of the sensor depend on the maximum ranges desired, notably 160 kg in the case of a scale for weighing persons. The high strains existing in the fixations of the sensor in the base or support zone and in the weighing platform must be distributed over sufficiently large contact surfaces. In addition, the surfaces for distributing the strains must be calculated in order to assure a good strength of the bond joint.

By its mounting in overhang between a platform and a base or a support zone, a weight sensor assembled by bonding subjects the bonding zone mainly to compression and shear strains, in particular at the ends of the bonded connection. Improvement of the bonded assembly consists in calculating a minimum surface of the bonding zone able to resist loads applied and to better distribute the strains across the bond joint. A good design of the bonded assembly seeks to create a bonding and mechanical force transmission surface that is as large as possible, but all while taking into account considerations of manufacturing cost.

Thus, after numerous experiments and tests effectuated in the workshop, it has finally been found, in the case of a bathroom scale having a single weight sensor arranged between the platform and the base, sensor that undergoes a maximum load and is thus subjected to flexure and torsion, the surface of the bonding zone should be equal to or greater than 30 cm² in order to support a load positioned at any location on the platform. In the same manner, a bathroom scale having a platform resting on at least three weight sensors, the surface of the bonding zone should be greater than 9 cm² in order to support a maximum load positioned at any location on the platform.

Preferably, the connection by bonding is in the form of a lap joint.

By lap joint there is understood a superposition of two surfaces separated by a cement joint. This type of joint assures a good compromise between the mechanical strength of the assembly by bonding and the ease of fabrication. In addition, the strength of such a type of joint depends on the thickness of the cement joint, it can thus be easily adapted to different materials and varied strains.

Advantageously, said adhesive is chosen from among the epoxy adhesives or polyacrylic adhesives polymerizing under UV or by heat.

The choice of adhesive depends on the nature of the substrates or of the strength that must be conferred on the assembly. Epoxy adhesives or polyacrylic adhesives polymerizing under UV or by heat permit two different materials to be joined together, for example metal on: glass, ceramic, Plexiglas®, stone or metal on metal, all while conserving the thermal treatment characteristics achieved and while assuring a sufficient resistance to static and dynamic strains as well as a good working life of the bond joint.

Such an adhesive is, for example, acrylic cement cross-linking under UV, reference 6128N of the company DELO when one of the planes to be bonded is a glass that is transparent to UV.

Usefully, the thickness of the adhesive used to achieve the bonding is chosen as a function of the nature of the materials to be bonded and it is preferably between 0.05 and 0.5 mm.

The thickness of the cemented joint determines its resistance to shear strains and it is chosen as a function of the material pair to be bonded. The thickness of the bond joint must be at the same time as thin as possible in order to integrally transmit, without damping, the value of the strain across the bond joint. Thus, for a steel sensor bonded on a steel platform and using an epoxy cement that polymerizes under heat, the thickness of the bond joint is between 0.05 and 0.25 mm. In contrast, when using the same cement for an aluminum/steel pair there should be provided a thickness of the bond joint between 0.2 and 0.4 mm in order to support the shear strains in the joint due to the different coefficients of expansion between the two substrates. It is the same for a tempered glass platform bonded to a steel sensor by using an epoxy cement or a polyacrylic cement cross-linked under UV, in which case the thickness of the bond joint should be between 0.25 and 0.5 mm.

Preferably, said platform is made of tempered glass or of metal.

The rigid platform of a weighing device can be made of various materials, such as, for example: metal, ceramic, Plexiglas®, stone or others having similar properties. There is preferred, however, a platform of tempered glass because it has good rigidity properties for small thickness dimensions, while having a good resistance to breakage by flexure, or a metal platform, the two materials having a good mechanical behavior for loads applied in such a type of device.

Advantageously, the weighing device of the invention has at least three weight sensors fixed with one of their fixing ends on the periphery of a platform, the opposite end being offset with respect to the platform and fixed to a support forming a foot of the device.

Such a device with several sensors is simple to construct while permitting very precise measurements to be taken, since errors due to parasitic moments are minimized. In addition, the bending experienced by the sensors is weaker and the profile of the device is very thin.

Other characteristics and advantages of the invention will appear more clearly in light of the description and drawings that follow, illustrating, by way of non-limiting examples, embodiments of the invention. Thus, reference is made to the figures where:

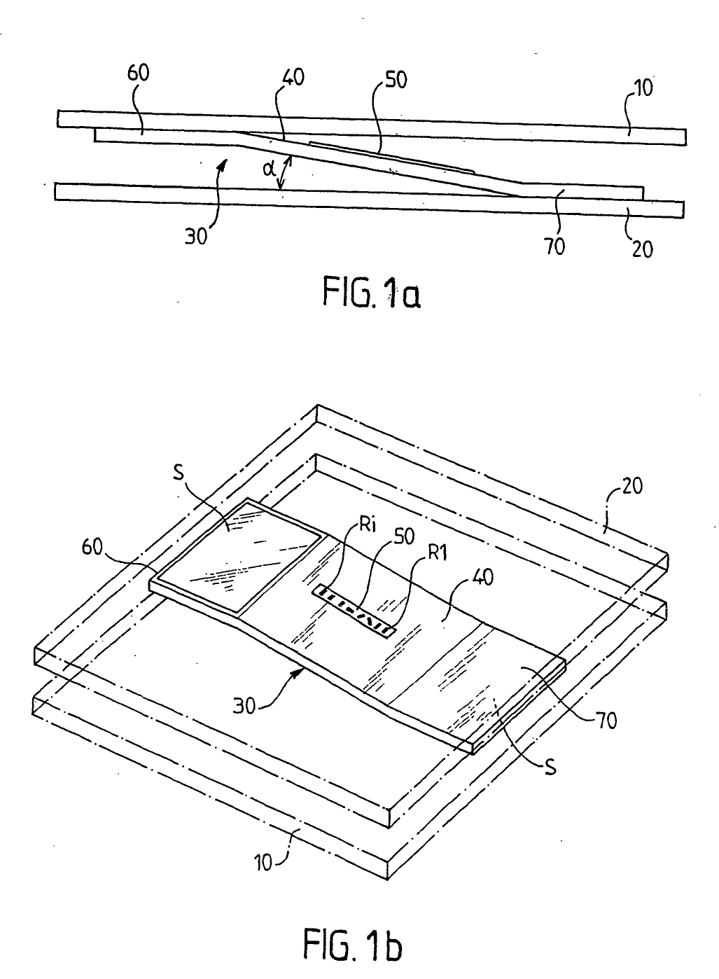

FIG. 1a is an axial cross-sectional view of a weighing device according to a first embodiment of the invention of which FIG. 1b illustrates a perspective view;

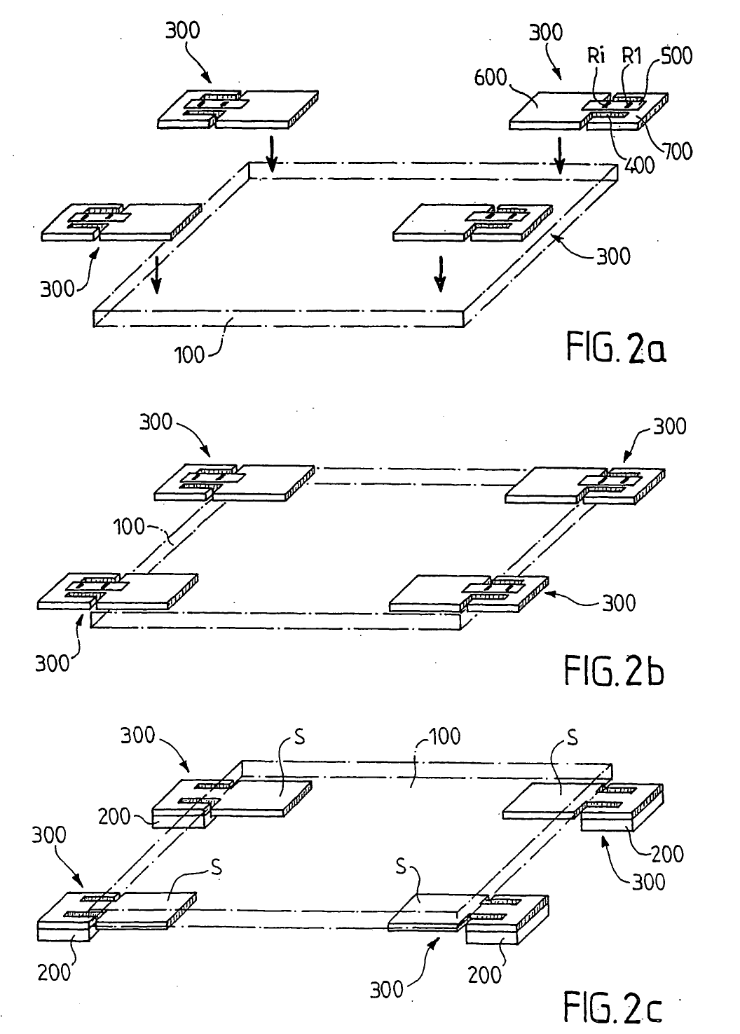

FIGS. 2a to 2c illustrate different views in perspective of a weighing device according to second embodiment of the invention.

The weighing device of the invention comprise a rigid platform 10, 100 capable of receiving the weight to be measured, at least one weight sensor 30, 300 having on one of its faces at least two strain gauges R1, Ri, one of the ends 60, 600 of the sensor being fitted to rigid platform 10, 100 and the other 70, 700 to a base or support zone 20, 200 intended to rest on a flat surface. The two ends 60, 600 and 70, 700 of the weight sensor delimit a flexure bar 40, 400 that is of an elastic material and that is deformable mainly by flexure under the effect of the weight to be weighed. By flexure bar 40, 400, there is designated a bar deformable mainly by flexure, but also supporting a weaker torsion force that appears depending on the manner of attachment of the sensor and the direction of application of the load. By way of example, deformations experienced by flexure bar 40, 400 can be due in a proportion of 70 to 99% to flexure forces, the torsion component acting for the remainder.

Strain gauges R1, Ri are screen printed on a thin plate 50, 500 of ceramic, for example of alumina, which is bonded on flexure bar 40, 400 in the direction of its length. Use can be made of two strain gauges R1, Ri mounted on one of the faces of the flexure bar, or several gauges mounted on one of the faces of the flexure bar or, for greater precision, the gauges could be mounted at one side and the other of this latter in the deformation zone. The gauges are connected by an arrangement mounting of the Wheatstone bridge type to an electronic circuit to convert the deformations experienced by the gauges into electric signals, to transform these latters into numerical values corresponding to the measured weight and to display them.

In the examples shown in the figures, weight sensor 30, 300 has a bonding surface S that is substantially flat, intended to contact that of a platform 10, 100 substantially flat. However, the surface (S) can be a curved surface, for example, for a platform having a curved form, it being important that the surfaces intended for the bonding, particularly the end surface of the sensor and the surface of the platform, be placed in good communication in order to form a bond joint of uniform thickness.

FIGS. 1a and 1b illustrate a first embodiment of the invention in which the weighing device has a weight sensor 30 in the form of a bar of tempered steel of square cross-section. The bar is mounted in overhang between rigid horizontal platform 10 for application of the weight and a fixed base 20 parallel to the first. Sensor 30 is made in a single piece with end parts 60, 70.

Sensor 30 has a central zone forming the flexure bar 40 which forms a certain angle α with its flat ends 60, 70. The angle of inclination α should permit displacement of platform 10 under the applied weight and it must be small in order to not introduce parasitic moments that are too large. Sensor 30 can be made by cutting and bending a steel sheet. On the central part or flexure bar 40 is bonded a plate of alumina supporting strain gauges R1, Ri disposed symmetrically with respect to the center of bar 50.

The flat parts of ends 60, 70 each have a flat surface S intended for attachment by cementing with platform 10, respectively base 20. Surface S is calculated to assure on the one hand a good distribution of strains at the junction points between the sensor and the platform, respectively the base and, on the other hand to assure the reliability and the mechanical strength of the bonded assembly.

FIGS. 2a to 2c show a second embodiment of the invention where rigid platform 100 rests on four flat sensors 300. Each sensor 300 is made in the form of a single flat piece initially of rectangular form in which are left slots in a manner to define a central flexure bar 400 having at one of its ends a rectangular surface 600 and at the opposed end a part 700 in the form of a U. Sensor 300 is fixed by cementing with its end 600 to rigid platform 100, while the opposite end comes to bear on a foot 200 of hollow form. On flexure bar 400 is cemented a plate 500 of alumina having two strain gauges R1, Ri on its face that faces the foot. Bar 400 flexes under the effect of the weight applied on platform 100 and the deformations of the gauges are translated by the electronic circuit into weight values that are displayed by the device.

The bonding surface S of end 600 of sensor 300 is dimensioned, as for the preceding embodiments, in order to support a maximum load applied on the platform and to create an assembly by strong bonding, able to uniformly transmit the strains of platform 100 to deformable part 400 of sensor 300.

Sensor 30, 300 of the invention is made of tempered steel. Platform 10, 100 can be made of various materials, notable: of glass, steel, aluminum, Plexiglas®, ceramic, stone. The base or support zone 20, 200 can be made of the same material as the platform or of a different material.

According to the invention, one end 60, 600 of sensor 30, 300 is assembled by bonding to platform 10, 100 and/or equally the opposed end 70, 700 to the base or support zone 20, 200. For this, the totality of the bonding surface defined previously by the surface S of the sensor is coated with an adhesive deposited in a certain quantity in order to obtain, by polymerization, a joint having a predetermined thickness. The thickness of the bond joint is precisely determined to assure a good mechanical behavior of the sensor with respect to the base for application of strains.

The choice of adhesive is made as a function of the nature of the materials to be bonded and as a function of the strains that are exerted on the bonded assembly. The adhesives utilized in the framework of the invention are epoxy adhesives or polyacrylic adhesives that polymerize under UV or by heat.

FIGS. 2a and 2b show an example of construction of the assembly in which sensors 300 are applied on platform 100 in the direction of the arrows, their end 600 being coated with adhesive over the entire surface S. Sensors 300 and platform 100 are maintained in contact for a certain time at a predetermined temperature, with or without the application of UV radiation in order to achieve polymerization of the adhesive layer. Once the bonding is achieved, the other end 700 is fixed in a support zone or foot 200 by any mechanical assembly method, or equally by bonding.

Other variants and embodiments of the invention can be imagined without departing from the framework of its claims. Thus, one can imagine the use of any type of material for the platform and/or the base and any other form for the sensor on the condition of respecting the conditions linked to the calculation of the optimum bonded surface and of well respecting the thickness of the bond joint as a function of the nature of the adhesive and of the substrates.

1. Weighing device comprising a rigid platform (10, 100) intended to receive the weight to be measured, a fixed support zone (20, 200) and at least one weight sensor (30, 300) fixed at one of its ends in the platform (10, 100) and at the opposite end (70, 700) in the fixed support zone (20, 200), said weight sensor (30, 300) having a bar (40, 400) that is deformable mainly by flexure under the effect of the weight applied on said platform and carrying strain gauges (R1, Ri), characterized in that at least one of the fixing ends (60, 600) of said weight sensor presents a surface (S) intended to be directly fixed by bonding to the rigid platform (10, 100) or to the fixed support zone (20, 200).

2. Weighing device according to claim 1, characterized in that said flat surface (S) defines a bonding zone per sensor inversely proportional to the number of weight sensors (30, 300) of the device.

3. Weighing device according to claim 1, characterized in that the connection by bonding is in the form of a lap joint.

4. Weighing device according to claim 1, characterized in that said adhesive is chosen from among the epoxy adhesives or polyacrylic adhesives polymerizing under UV or by heat.

5. Weighing device according to claim 4, characterized in that the thickness of the adhesive used to achieve the bonding is chosen as a function of the nature of the materials to be bonded and it is preferably between 0.05 and 0.5 mm.

6. Weighing device according to claim 1, characterized in that said platform (10, 100) is made of tempered glass or of metal.

7. Weighing device according to claim 1, characterized in that it comprises at least three weight sensors (300) fixed with one of their fixing ends (600) on the periphery of a platform (100), the opposite end being offset with respect to the platform and fixed to a support forming a foot of the device.
